(19) United States
(12) Patent Application Publication
(10) Pub. No.: US 2011/0134075 A1
(43) Pub. Date: Jun. 9, 2011

(54) TOUCH PANEL, DISPLAY, AND ELECTRONIC DEVICE

(75) Inventor: Yasunobu Takusa, Osaka-shi (JP)

(73) Assignee: SHARP KABUSHIKI KAISHA, Osaka-shi, Osaka (JP)

(21) Appl. No.: 13/056,711

(22) PCT Filed: May 21, 2009
(86) PCT No.: PCT/JP2009/002251

§ 371 Date: Jan. 31, 2011

(30) Foreign Application Priority Data
Aug. 7, 2008 (JP) 2008-203754

(51) Int. Cl. G06F 3/044; G06F 3/041

(52) U.S. Cl. 345/174; 345/173

(57) ABSTRACT

A touch panel (20a) including: a touch detection electrode (11) provided on a first substrate (10); a lead line (13a, 13b) routed from the touch detection electrode (11) along a periphery of the first substrate (10) to an area along one side edge of the first substrate (10), the lead line including a connection terminal T formed in the area; and an external line (16) provided on a second substrate (15a) secured to the area along the one side edge of the first substrate (10) and connected to the connection terminal (T), wherein the connection terminal (T) of the lead line (13a, 13b) is formed in a linear pattern along the one side edge of the first substrate (10), and the external line (16) includes a connection portion (16a) provided so as to overlap the connection terminal (T), and a line portion (16b) bending from the connection portion (16a) to extend in a direction away from the touch detection electrode (11).

### TECHNICAL FIELD

The present invention relates to a touch panel, a display device, and an electronic device.

### BACKGROUND ART

An electronic device having a display device provided with a touch panel can be controlled by, for example, touching on an icon, or the like, displayed on the display screen of the display device via the touch panel. For example, a touch panel can read a trace left on the display screen by a finger, thus enabling various actions based on human operations on the display screen such as to hand-write characters and drawings, and to make a gesture such as flicking on the display screen in one direction for an operation such as enlarging or shrinking displayed image or turning the page. Thus, touch panels are recently provided in various electronic devices such as ATMs (automated teller machines), ticket-vending machines, personal computer monitors, car navigation systems, game machines, PDAs (personal digital assistants), photocopiers, and mobile telephones, and are indispensable input means particularly for on-vehicle car navigation systems.

For example, Patent Document 1 discloses a narrow-frame touch panel including a circuit sheet provided between an upper electrode member and a lower electrode member, wherein the circuit sheet is a flexible insulative base which is frame-shaped and includes an integral external connection portion on one side protruding out of the frame with busbars and routing circuits provided on the upper surface and the lower surface of the insulative base. It is stated that it is not necessary to provide space along one side of the touch panel for the insertion/pressing of an end portion of a flexible printed circuit, as a connector, and it is possible to narrow the frame along four sides of the touch panel.

### CITATION LIST

### Patent Document

PATENT DOCUMENT 1: Japanese Laid-Open Patent Publication No. 2004-240662

### SUMMARY OF THE INVENTION

### Technical Problem

FIG. 12 is a plan view showing a conventional capacitive touch panel 120.

As shown in FIG. 12, the touch panel 120 includes, for example, a rectangular insulative substrate 110, a transparent touch detection electrode 111 provided in a rectangular shape on the insulative substrate 110, a frame line 112 provided in a frame shape along the periphery of the touch detection electrode 111, and four lead lines 113 provided so as to extend with bends from four corners of the frame line 112 to an area along one side edge of the insulative substrate 110. As shown in FIG. 12, in the touch panel 120, the lead lines 113 are connected to an external position detection circuit (not shown) via an FPC (flexible printed circuit) 114 for detecting the touched position. In the touch panel 120 provided in a display device, a display area for displaying an image is defined inside the frame line 112, and a frame area is defined around the display area.

As described above, with a conventional touch panel, at least some of the plurality of lead lines for external connection are bent in the frame area along the periphery of the substrate, and the connection terminals at the end of the lead lines are formed in a direction perpendicular to one side edge of the substrate. Thus, in a display device provided with the touch panel or an electronic device provided with the display device, the frame area is increased with respect to the display area, and the device as a whole becomes large. Particularly, with an electronic device for mobile applications, there is a demand for increasing the display area while making the device as a whole compact so that the device can be carried around in a pocket or a bag. Touch panels are manufactured by subjecting a large substrate of a prescribed size to processes such as thin film formation and then cutting it into pieces. Therefore, if the frame area increases, the number of touch panels obtained from a large substrate of a prescribed size, thus lowering the touch panel manufacturing efficiency.

The present invention has been made in view of the above, and has an object of improving the manufacturing efficiency by reducing the frame area as much as possible.

### Solution to the Problem

In order to achieve the object above, in the present invention, a connection terminal of a lead line of a touch detection electrode provided on a first substrate is formed in a linear pattern along one side edge of the first substrate, and an external line provided on a second substrate includes a connection portion provided so as to overlap the connection terminal, and a line portion bending from the connection portion.

Specifically, a touch panel of the present invention includes: a touch detection electrode provided on a rectangular first substrate so as to be capable of touch detection; a lead line routed from the touch detection electrode along a periphery of the first substrate to an area along one side edge of the first substrate, the lead line including a connection terminal formed in the area; and an external line provided on a second substrate secured to the area along the one side edge of the first substrate and connected to the connection terminal, wherein a touched position on the touch detection electrode is detected via the lead line and the external line, the connection terminal of the lead line is formed in a linear pattern along the one side edge of the first substrate, and the external line includes a connection portion provided so as to overlap the connection terminal, and a line portion bending from the connection portion to extend in a direction away from the touch detection electrode.

With such a configuration, on the rectangular first substrate, the lead line routed from the touch detection electrode along the periphery of the substrate to the area along one side edge of the substrate includes the connection terminal in the area, and the connection terminal is formed in a linear pattern along one side edge of the substrate. Therefore, the width of the area along the one side edge of the first substrate where the connection terminal is formed, i.e., the width of one side of the frame area where the connection terminal is formed, can be made smaller as compared with a case where the lead line bends in the area along one side edge of the substrate to form the connection terminal (see FIG. 12), for example. On the second substrate secured to the area along the one side edge of the first substrate, the connection portion of the external line is provided so as to overlap the connection terminal for the connection to the connection terminal on the first substrate, and the line portion of the external line is provided so as to be bending from the connection portion to extend in a direction away from the touch detection electrode on the first substrate. Therefore, the touch detection electrode is connected to an external position detection circuit, for example, via the lead line and the external line. Thus, on the touch panel including a substrate such as an FPC for the connection to the position detection circuit, the width of one of the frame areas along four sides where the connection terminal is formed is reduced, and it is therefore possible to reduce the frame area as much as possible and to improve the manufacturing efficiency.

The second substrate may be a flexible substrate having flexibility.

With such a configuration, since the second substrate is a flexible substrate such as an FPC, it is possible to realize the second substrate easily and inexpensively, and it is also possible to further reduce the size of the frame area by securing the second substrate to first substrate while the second substrate is bent.

A plurality of lead lines may be provided for the touch detection electrode, and the connection terminals of the lead lines may be provided so as to be next to each other.

With such a configuration, since the connection terminals of the lead lines are provided so as to be next to each other, it is possible to reduce the area of the second substrate where the connection portions to be connected to the connection terminals of the lead lines, i.e., the external lines, are formed.

A plurality of lead lines may be provided for the touch detection electrode, and the plurality of lead lines may include a first lead line routed from the touch detection electrode in one of a clockwise direction and a counterclockwise direction, and a second lead line routed from the touch detection electrode in the other one of the clockwise direction and the counterclockwise direction.

With such a configuration, the plurality of lead lines include the first lead line and the second lead line which are routed from the touch detection electrode respectively in one of the clockwise direction and the counterclockwise direction and in the other one of the clockwise direction and the counterclockwise direction. Therefore, as compared with a case where the plurality of lead lines are routed from the touch detection electrode in the same direction, the width of one side of the frame area where the connection terminal is formed is reduced, and it is possible to reduce the frame area. Since it is possible to reduce the width of one side of the frame area where the connection terminal is formed without employing multi-layer lines, the manufacturing process is simplified, and it is easier to improve the manufacturing yield.

An alignment mark for aligning the first substrate and the second substrate with each other may be provided between a connection terminal of the first lead line and a connection terminal of the second lead line.

With such a configuration, the alignment mark is provided between the connection terminal of the first lead line and the connection terminal of the second lead line. Therefore, even if alignment marks for aligning the first substrate and the second substrate with each other are provided on the first substrate and the second substrate, the width of one side of the frame area where the connection terminals are formed remains small.

A pair of alignment marks may be provided so as to be spaced apart from each other along the one side edge of the first substrate.

With such a configuration, a pair of alignment marks are provided so as to be spaced apart from each other along the one side edge of the first substrate. Therefore, by aligning the first substrate and the second substrate with each other so that the pair of alignment marks on the first substrate are overlapped with a corresponding pair of alignment marks on the second substrate, it is possible to reduce the angular misalignment of the second substrate with respect to the first substrate, and it is possible to reduce the misalignment of the second substrate with respect to the first substrate in a direction along the one side edge of the first substrate, thereby reducing short-circuiting, etc., and improving the manufacturing yield and the product quality.

A pair of alignment marks may be provided so as to be spaced apart from each other in a direction perpendicular to one side edge of the first substrate.

With such a configuration, a pair of alignment marks are provided so as to be spaced apart from each other in a direction perpendicular to one side edge of the first substrate. Therefore, by aligning the first substrate and the second substrate with each other so that the pair of alignment marks on the first substrate are overlapped with a corresponding pair of alignment marks on the second substrate, it is possible to reduce the misalignment of the second substrate with respect to the first substrate in a direction perpendicular to one side edge of the first substrate, thereby reducing at least one of the line width and the line interval of the connection terminals, hence the connection pitch, and it is therefore possible to reduce the width of one side of the frame area where the connection terminals are formed.

A touched position on the touch detection electrode may be detected by a capacitive system.

With such a configuration, a capacitive touch panel is realized, and a substrate with higher rigidity than a resistive touch panel can be used as the first substrate. Therefore, with a display device and an electronic device including the touch panel, it is possible to maintain a desirable display quality. Since there is only one substrate including the touch detection electrode, i.e., the first substrate, it is possible to reduce the thickness, reduce the weight and simplify the manufacturing process of a touch panel. Moreover, with a capacitive touch panel, i.e., with a capacitive touch panel in which the touch detection electrode is formed in a single layer, as compared with a case where electrode layer lines cross each other with an insulative film interposed therebetween or a case where the touch detection electrode is formed by multiple layers, it is possible to simplify the manufacturing process, and since the product structure and the electrode pattern are simple, it is possible to significantly reduce the fraction defective.

The touch detection electrode may be provided in a rectangular shape entirely across an area inside a frame area defined along the periphery of the first substrate.

With such a configuration, an analog-type capacitive touch panel is realized, and it is therefore possible to increase the touch detection area within the rectangular touch panel area, and to reduce the thickness of the touch panel and simplify the manufacturing process.

A display device of the present invention includes a touch panel described above.

With such a configuration, since the frame area of the touch panel is reduced as much as possible, the frame area of the display device including the touch panel is also reduced as much as possible, and it is possible to reduce the size of the display device.

The display device may include a display panel including a pair of substrates arranged opposing each other, wherein the first substrate is one of the pair of substrates.

With such a configuration, since the substrate of the touch panel (the first substrate) and the substrate of the display panel (one of the pair of substrates) are provided as a shared member, the generation of reflected light due to the substrate of the touch panel is reduced and it is possible to improve the display quality of the display device, and it is also possible to reduce the thickness of the display device. Moreover, the manufacturing process is simplified, and it is easier to improve the manufacturing yield.

An electronic device of the present invention includes a display device described above.

With such a configuration, since the frame area of the display device is reduced as much as possible, the frame area of the electronic device including the display device is also reduced as much as possible, and it is possible to reduce the size of the electronic device.

The electronic device may include a cover substrate for protecting a surface, wherein the first substrate is the cover substrate.

With such a configuration, since the cover substrate for protecting the surface of the electronic device and the substrate of the touch panel (the first substrate) are provided as a shared member, the generation of reflected light due to the substrate of the touch panel is reduced and it is possible to improve the display quality of the electronic device, and it is also possible to reduce the thickness of the electronic device. Moreover, the manufacturing process is simplified, and it is easier to improve the manufacturing yield.

An electronic device of the present invention includes a touch panel described above.

With such a configuration, since the frame area of the touch panel is reduced as much as possible, the frame area of the electronic device including the touch panel is also reduced as much as possible, and it is possible to reduce the size of the electronic device.

The electronic device may include a cover substrate for protecting a surface, wherein the first substrate is the cover substrate.

With such a configuration, since the cover substrate for protecting the surface of the electronic device and the substrate of the touch panel (the first substrate) are provided as a shared member, it is possible to reduce the thickness of the electronic device. Moreover, the manufacturing process is simplified, and it is easier to improve the manufacturing yield.

### Advantages of the Invention

According to the present invention, the connection terminal of the lead line of the touch detection electrode provided on the first substrate is formed in a linear pattern along one side edge of the first substrate, and the external line provided on the second substrate includes the connection portion provided so as to overlap the connection terminal and the line portion bending from the connection portion, and it is therefore possible to reduce the frame area as much as possible and to improve the manufacturing efficiency.

### BRIEF DESCRIPTION OF THE DRAWINGS

FIG. 1 is a plan view showing a touch panel 20a of Embodiment 1.

FIG. 2 is a cross-sectional view showing the touch panel 20a and a liquid crystal display device 40a including the same taken along line II-II in FIG. 1.

FIG. 3 are schematic views showing alignment marks M formed on the touch panel 20a.

FIG. 4 is a perspective view showing a digital camera 50a including the liquid crystal display device 40a.

FIG. 5 is a front view showing a mobile telephone 50b including the liquid crystal display device 40a.

FIG. 6 is a cross-sectional view showing an electronic device 50c of Embodiment 2.

FIG. 7 is a cross-sectional view showing a liquid crystal display device 40c of Embodiment 3.

FIG. 8 is a plan view showing a touch panel 20b of Embodiment 4.

FIG. 9 is a cross-sectional view showing the touch panel 20b taken along line IX-IX in FIG. 8.

FIG. 10 is a cross-sectional view showing a mobile telephone 50d of Embodiment 5.

FIG. 11 is a cross-sectional view showing a remote controller 50e of Embodiment 5.

FIG. 12 is a plan view showing a conventional capacitive touch panel 120.

### DESCRIPTION OF EMBODIMENTS

Embodiments of the present invention will now be described in detail with reference to the drawings. Note that the present invention is not limited to the following embodiments.

### Embodiment 1 of Invention

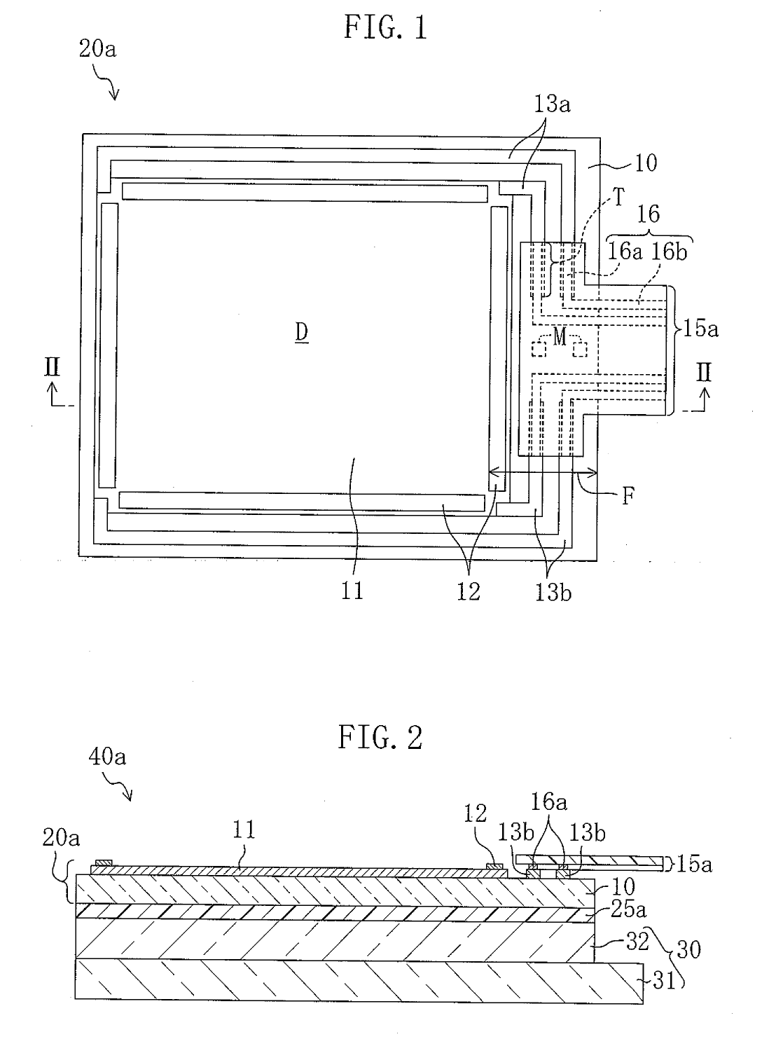

FIGS. 1-5 show a touch panel, a display device and an electronic device according to Embodiment 1 of the present invention. Specifically, FIG. 1 is a plan view showing a touch panel 20a of the present embodiment, and FIG. 2 is a cross-sectional view showing the touch panel 20a and a liquid crystal display device 40a including the same taken along line II-II in FIG. 1.

As shown in FIG. 2, the liquid crystal display device 40a includes, for example, an active matrix-type liquid crystal display panel 30, the analog-type capacitive touch panel 20a provided on the liquid crystal display panel 30 with an adhesive layer 25a interposed therebetween.

As shown in FIG. 2, the liquid crystal display panel 30 includes an active matrix substrate 31 and a counter substrate 32 provided as a pair of substrates placed so as to oppose each other, and a liquid crystal layer (not shown) provided between the active matrix substrate 31 and the counter substrate 32. Note that a polarizer (not shown) is bonded to the upper surface and the lower surface of the liquid crystal display panel 30.

For example, the active matrix substrate 31 includes: a plurality of gate lines (not shown) provided so as to extend parallel to each other on a glass substrate; a gate insulating film (not shown) provided so as to cover the gate lines; a plurality of source line (not shown) provided so as to extend parallel to each other in a direction perpendicular to the gate lines on the gate insulating film; a plurality of TFTs (Thin Film Transistors, not shown) provided at the intersections between the gate lines and the source lines; an interlayer insulating film (not shown) provided so as to cover the TFTs and the source lines; a plurality of pixel electrodes (not shown) provided in a matrix pattern on the interlayer insulating film and connected to the TFTs; and an alignment film (not shown) provided so as to cover the pixel electrodes. Here, the pixel electrodes each form a pixel which is the minimum unit of an image, and are arranged in a matrix pattern so as to form a display area as a whole for displaying an image.

For example, the counter substrate 32 includes: a black matrix (not shown) provided in a frame pattern including a lattice pattern inside the frame on a glass substrate; colored layers (not shown) such as red layers, green layers and blue layers provided between lattice strips of the black matrix; a common electrode (not shown) provided so as to cover the black matrix and the colored layers; and an alignment film (not shown) provided so as to cover the common electrode.

As shown in FIGS. 1 and 2, the touch panel 20a for example includes a rectangular first substrate 10 such as a glass substrate, and a T-shaped second substrate 15a such as an FPC (flexible printed circuit) secured to an area along one side edge (the right side in FIG. 1) of the first substrate 10 with an ACF (Anisotropic Conductive Film, not shown) interposed therebetween.

As shown in FIGS. 1 and 2, a touch detection electrode 11 is provided in a rectangular shape on the upper surface of the first substrate 10, and frame lines 12 are provided on the touch detection electrode 11 so as to extend along different sides thereof, with a pair of first lead lines 13a and a pair of second lead lines 13b provided so as to be routed from different corners of the touch detection electrode 11 along the periphery of the substrate to an area along one side edge (the right side in FIG. 1) of the substrate. Note that the frame lines 12 may be connected together into a frame shape.

The touch detection electrode 11 is formed by a transparent conductive film, a colored semi-transparent conductive film, or the like, made of ITO (Indium Tin Oxide), an organic conductive material, or the like, for example.

For example, the frame lines 12, the first lead lines 13a and the second lead lines 13b are each a relatively thin, single-layer or multi-layer metal film made of one of, or an alloy of, aluminum, titanium, copper, molybdenum, tantalum, and the like, or a relatively thick metal film made of a conductive paste of silver, palladium, silver-palladium, copper, or the like.

The frame lines 12 are a linearization pattern for making the electric field distributed evenly over the touch detection electrode 11 and for improving the linearity thereof. Note that while the pattern shape of the frame lines 12 is not shown in the figure, the frame lines 12 may have a complicated pattern shape.

As shown in FIG. 1, the first lead lines 13a are routed from the upper left corner and the upper right corner of the touch detection electrode 11 in the clockwise direction.

As shown in FIG. 1, the second lead lines 13b are routed from the lower left corner and the lower right corner of the touch detection electrode 11 in the counterclockwise direction.

As shown in FIG. 1, at the end of each of the first lead lines 13a and the second lead lines 13b, a linear connection terminal T is provided so as to extend along one side edge (the right side in FIG. 1) of the first substrate 10. Note that the interval between the connection terminals T is, for example, about several 100 μm.

For each of the first lead lines 13a and the second lead lines 13b, the connection terminals T are provided so as to lie next to each other as shown in FIG. 1.

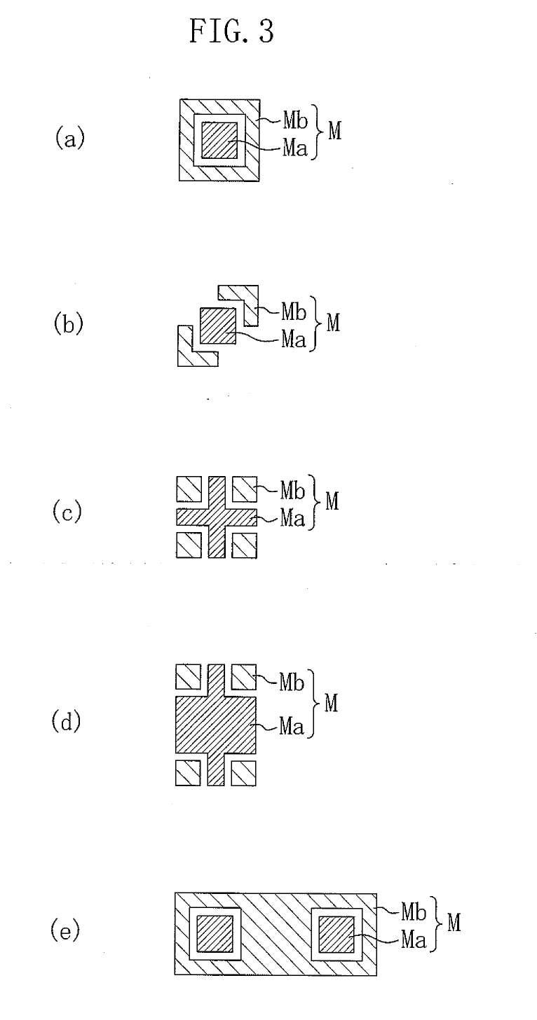

As shown in FIG. 1, a pair of alignment marks M for aligning the first substrate 10 and the second substrate 15a with each other are provided between the area where the connection terminals T of the first lead lines 13a are provided and the area where the connection terminals T of the second lead lines 13b are provided so that the alignment marks M are spaced apart from each other in a direction perpendicular to one side edge (the right side in FIG. 1) of the first substrate 10. Now, FIG. 3 is a schematic view showing the alignment marks M formed on the touch panel 20a.

As shown in FIGS. 3(a)-3(e), the alignment mark M includes, for example, a lower mark Ma provided on the first substrate 10, and an upper mark Mb provided on the second substrate 15a.

Specifically, in FIG. 3(a), the lower mark Ma is provided in a square shape, and the upper mark Mb is provided in a frame shape so as to surround the lower mark Ma.

In FIG. 3(b), the lower mark Ma is provided in a square shape, and the upper mark Mb is formed in a pattern of a pair of L-letter shapes so as to surround the lower mark Ma.

In FIGS. 3(c) and 3(d), the lower mark Ma is provided in a cross shape, and the upper mark Mb is provided in a pattern of four squares so as to surround the lower mark Ma in diagonal directions of the lower mark Ma.

In FIG. 3(e), the lower mark Ma is provided in a pattern of two square shapes spaced apart from each other, and the upper mark Mb is provided in a rectangular shape with two square openings so as to accommodate the lower marks Ma therein as viewed from above.

An insulating layer made of an organic resin film such as an acrylic resin may be provided on the upper surface of the first substrate 10 so as to cover the touch detection electrode 11, the frame lines 12, and portions of the first lead lines 13a and the second lead lines 13b excluding the connection terminals T. Note that the insulating layer is preferably an organic resin film not containing carboxylic acid so as to suppress deterioration of the transparent conductive film made of ITO.

As shown in FIG. 1, four L-shaped external lines 16 are provided on the lower surface of the second substrate 15a so as to be connected to the connection terminals T of the first lead lines 13a and the second lead lines 13b on the first substrate 10.

As shown in FIG. 1, the external line 16 includes a connection portion 16a provided so as to overlap the connection terminal T, and a line portion 16b bending from the connection portion 16a so as to extend in a direction away from the touch detection electrode 11. Here, the external line 16 is made of a copper foil, or the like, forming the conductive layer of the FPC. Note that the line portion 16b may be bent at a position that coincides with the end of the connection terminal T, or may be bent at a position that is about several mm outside (away from the terminal) or inside (into the terminal) from the coincided position.

An insulating layer made of an organic resin film is provided on the lower surface of the second substrate 15a so as to cover the line portions 16b of the external lines 16. Note that the insulating layer is formed by a cover film of the FPC, or the like.

As shown in FIG. 1, defined on the touch panel 20a are a display area D for displaying an image inside the frame lines 12, and a frame area F around the display area D where the frame lines 12, the first lead lines 13a and the second lead lines 13b are arranged.

The adhesive layer 25a is for example an acrylic resin, and by appropriately adjusting the refractive index thereof, it is possible to reduce reflection at the inter-material interface occurring due to the refractive index difference between materials, and to improve the display quality.

With the liquid crystal display device 40a having such a configuration, a predetermined voltage is applied to the liquid crystal layer between the active matrix substrate 31 and the counter substrate 32 so as to adjust the optical transmittance through the liquid crystal display panel 30 to thereby display an image through the touch panel 20a, and when the surface of the touch detection electrode 11 is touched via a cover substrate (not shown) or a protection film (not shown), the touch detection electrode 11 is grounded through the capacitance of the human body at the touched position, thereby varying capacitances between different corners of the touch detection electrode 11 and the touched position. Then, the touched position is calculated and detected by software by means of a built-in IC (integrated circuit) in a position detection circuit (not shown) connected to the external lines 16 based on the current values flowing through the first lead lines 13a and the second lead lines 13b, i.e., through the external lines 16. Note that while in the touch panel 20a of the present embodiment, a total of four lead lines including the first lead lines 13a and the second lead lines 13b are connected to the touch detection electrode 11 so that the touch position on a plane with a two-dimensional extent is detected by measuring the current flow through the first lead lines 13a and the second lead lines 13b, the number of lead lines connected to the touch detection electrode 11 is not limited to four. Here, while the minimal number of lead lines needed to detect a two-dimensional position is three, it is possible to improve the position detection precision by increasing the number of lead lines to five or more.

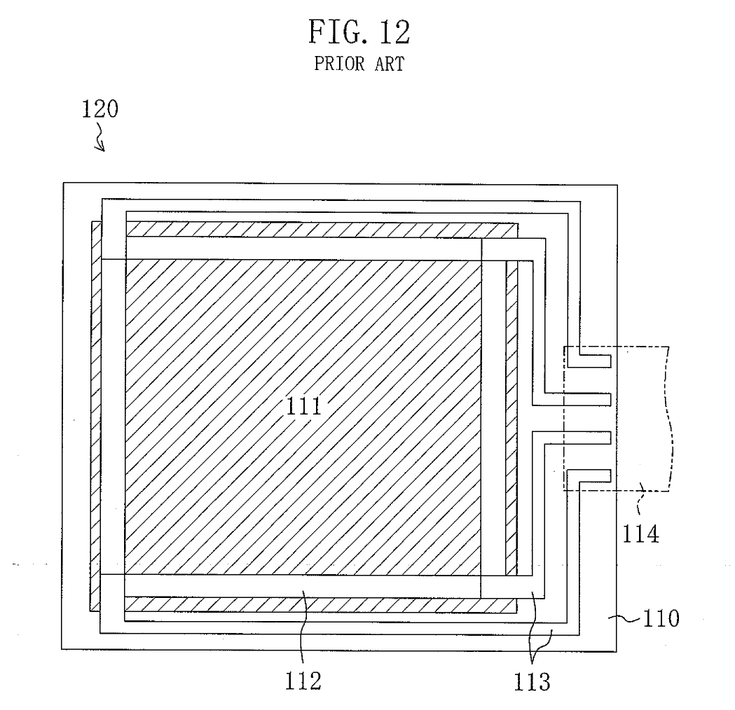

As described above, on the rectangular first substrate 10 of the touch panel 20a of the present embodiment, the first lead lines 13a and the second lead lines 13b routed from the touch detection electrode 11 to an area along one side edge of the substrate along the periphery of the substrate have the connection terminals T in that area, and the connection terminals T are formed in a linear pattern along one side edge of the substrate. Therefore, for example, as compared with a case where the lead lines are bent in the area along one side edge of the substrate to form connection terminals (see FIG. 12), the width of the area along one side edge of the first substrate 10 where the connection terminals T are formed, i.e., the width of one side of the frame area F where the connection terminals T are formed can be reduced. On the second substrate 15a secured to the area along one side edge of the first substrate 10, the connection portions 16a of the external lines 16 are provided so as to overlap the connection terminals T on the first substrate 10 because they are to be connected to the connection terminals T, with the line portions 16b of the external lines 16 bending from the connection portions 16a so as to extend in a direction away from the touch detection electrode 11 on the first substrate 10. Therefore, the touch detection electrode 11 is connected to an external position detection circuit, for example, via the first lead lines 13a, the second lead lines 13b and the external lines 16. Thus, on the touch panel including a substrate such as an FPC for the connection to the position detection circuit, the width of one of the frame areas along four sides where the connection terminals are formed is reduced, and it is therefore possible to reduce the frame area as much as possible and to improve the manufacturing efficiency.

With the liquid crystal display device 40a of the present embodiment, since the frame area F of the touch panel 20a is reduced as much as possible, the frame area of the liquid crystal display device 40a including the touch panel 20a is also reduced as much as possible, and it is possible to reduce the size of the liquid crystal display device 40a.

With the touch panel 20a of the present embodiment and the liquid crystal display device 40a including the same, since the second substrate 15a is a flexible substrate such as an FPC, it is possible to realize the second substrate 15a easily and inexpensively, and it is also possible to further reduce the size of the frame area F by securing the second substrate 15a to the first substrate 10 while the second substrate 15a is bent.

With the touch panel 20a of the present embodiment and the liquid crystal display device 40a including the same, the connection terminals T are provided so as to lie next to each other for each of the first lead lines 13a and the second lead lines 13b, and it is therefore possible to reduce the area of the second substrate 15a where the connection portions 16a to be connected to the connection terminals T of the first lead lines 13a and the second lead lines 13b, i.e., the external lines 16, are formed. Moreover, since the area of the second substrate 15a is reduced, it is possible to reduce wrinkles, warping, stretching and shrinking of the second substrate 15a due to the thermal history, the water absorption, etc., occurring when the second substrate 15a is processed, and it is possible to process the second substrate 15a with high precision.

With the touch panel 20a of the present embodiment and the liquid crystal display device 40a including the same, the plurality of lead lines are formed by the first lead lines 13a and the second lead lines 13b routed in the clockwise direction and in the counterclockwise direction, respectively, from the touch detection electrode 11. Therefore, as compared with a case where the plurality of lead lines are routed in the same direction from the touch detection electrode, the width of one side of the frame area F where the connection terminals T are formed is reduced, and it is therefore possible to reduce the frame area F. Since it is possible to reduce the width of one side of the frame area F where the connection terminals T are formed without employing multi-layer lines, the manufacturing process is simplified, and it is easier to improve the manufacturing yield.

With the touch panel 20a of the present embodiment and the liquid crystal display device 40a including the same, since the alignment mark M is arranged between the connection terminals T of the first lead lines 13a and the connection terminals T of the second lead lines 13b, it is possible to reduce the width of one side of the frame area F where the connection terminals T are formed even if the alignment mark M for aligning the first substrate 10 and the second substrate 15a with each other is provided on the first substrate 10 and on the second substrate 15a.

With the touch panel 20a of the present embodiment and the liquid crystal display device 40a including the same, a pair of alignment marks M are provided spaced apart from each other in a direction perpendicular to one side edge of the first substrate 10. Therefore, by aligning the first substrate 10 and the second substrate 15a with each other so that the pair of alignment marks M on the first substrate 10 are aligned with a corresponding pair of alignment marks M on the second substrate 15a, it is possible to reduce the misalignment of the second substrate 15a with respect to the first substrate 10 in a direction perpendicular to one side edge of the first substrate 10, thereby reducing at least one of the line width and the line interval of the connection terminals, hence the connection pitch, and it is therefore possible to reduce the width of one side of the frame area F where the connection terminals T are formed.

With the touch panel 20a of the present embodiment, an analog-type capacitive touch panel is realized, and a substrate with higher rigidity than a resistive touch panel can be used as the first substrate 10. Therefore, with the liquid crystal display device 40a and electronic devices 50a and 50b to be described later including the touch panel 20a, it is possible to maintain a desirable display quality. Since there is only one substrate including the touch detection electrode 11, i.e., the first substrate 10, it is possible to reduce the thickness, reduce the weight and simplify the manufacturing process of a touch panel. Moreover, with an analog-type capacitive touch panel, i.e., a capacitive touch panel in which the touch detection electrode is formed in a single layer, as compared with a case where electrode layer lines cross each other with an insulative film interposed therebetween or a case where the touch detection electrode is formed by multiple layers, it is possible to simplify the manufacturing process, and since the product structure and the electrode pattern are simple, it is possible to significantly reduce the fraction defective. Since the touch detection electrode 11 is provided in a rectangular shape entirely across the area inside the frame area F, it is possible to increase the touch detection area within the rectangular touch panel area.

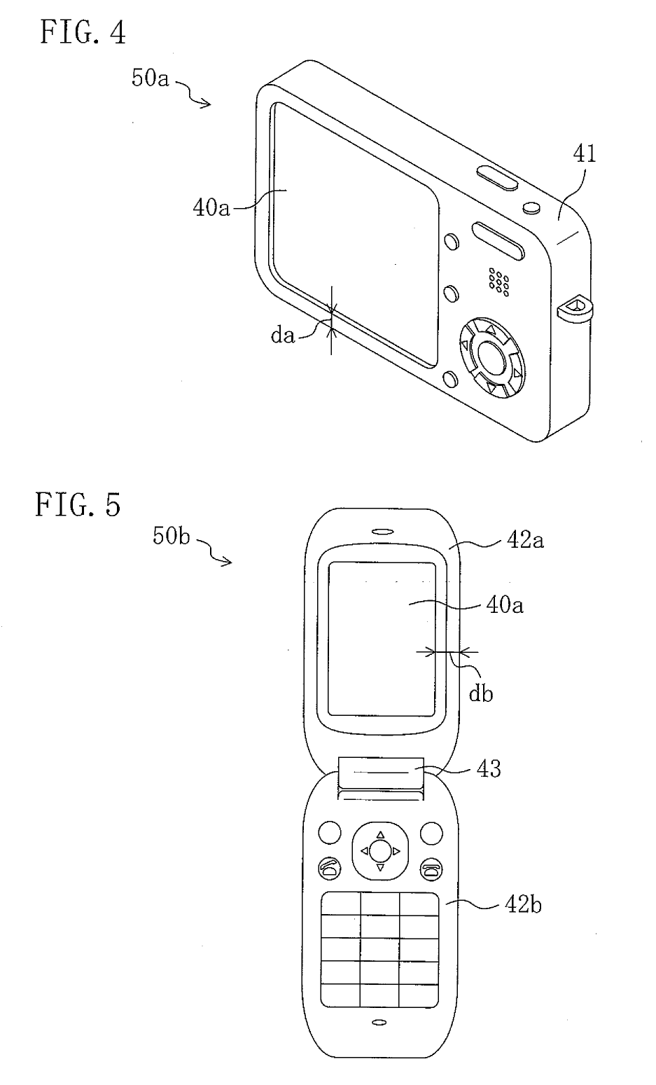

Here, FIGS. 4 and 5 each show an electronic device including the liquid crystal display device 40a. Specifically, FIG. 4 is a perspective view showing a digital camera 50a including the liquid crystal display device 40a, and FIG. 5 is a front view showing a mobile telephone 50b including the liquid crystal display device 40a.

As shown in FIG. 4, the digital camera 50a includes a casing 41 having an opening through which the display area D of the touch panel 20a of the liquid crystal display device 40a is exposed directly or with a cover therebetween, and the liquid crystal display device 40a accommodated in the casing 41. With the digital camera 50a, since the frame area of the liquid crystal display device 40a is reduced as described above, it is possible to reduce the width da of the frame area of the casing 41 as shown in FIG. 4, thereby reducing the size of the device body.

As shown in FIG. 5, the mobile telephone 50b includes a first casing 42a having an opening through which the display area of the touch panel 20a of the liquid crystal display device 40a is exposed directly or with a cover therebetween, the liquid crystal display device 40a accommodated in the first casing 42a, and a second casing 42b provided so that it can be folded onto the first casing 42a via a hinge portion 43. With the mobile telephone 50b, since the frame area of the liquid crystal display device 40a is reduced as described above, it is possible to reduce the width db of the frame area of the first casing 42a as shown in FIG. 5, thereby reducing the size of the device body.

Note that while the liquid crystal display panel 30 and the touch panel 20a are bonded together by the adhesive layer 25a in the present embodiment, the liquid crystal display panel 30 and the touch panel 20a may be secured to each other by accommodating the liquid crystal display panel 30 and the touch panel 20a inside a casing with a gasket interposed between the liquid crystal display panel 30 and the touch panel 20a.

### Embodiment 2 of Invention

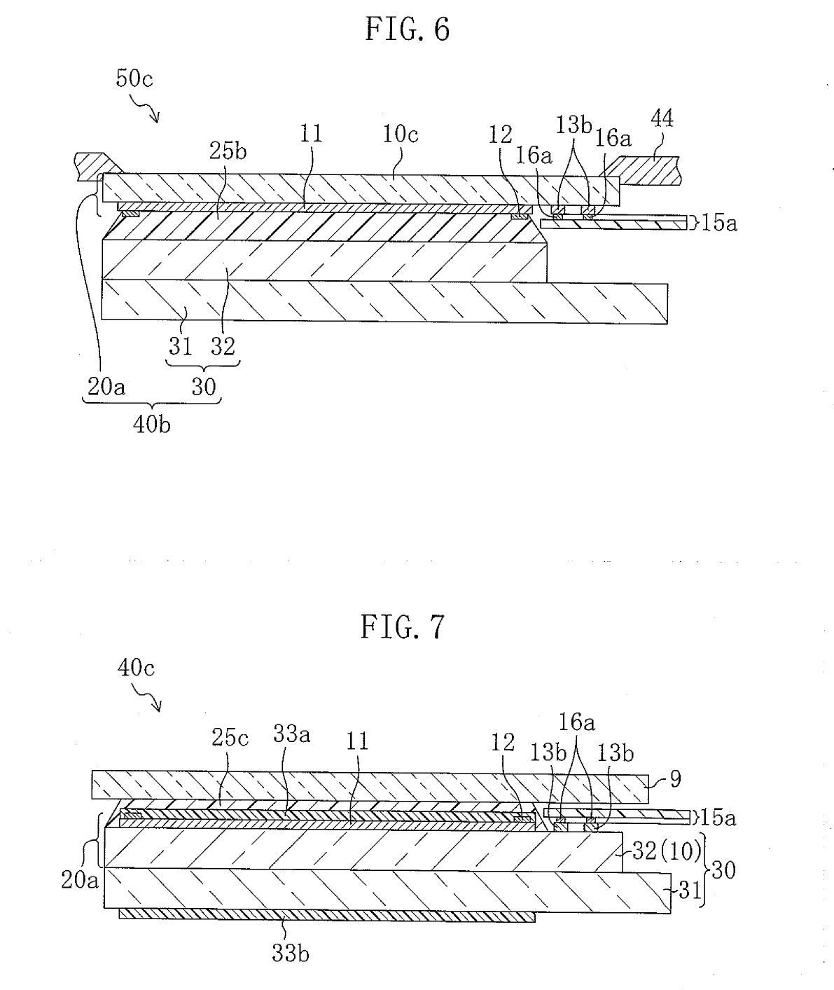

FIG. 6 is a cross-sectional view showing an electronic device 50c of the present embodiment. Note that in the following embodiments, like elements to those of FIGS. 1-5 will be denoted by like reference numerals and will not be described below in detail.

While the side of the touch panel 20a closer to the first substrate 10 is attached to the liquid crystal display panel 30 in Embodiment 1, the side of the touch panel 20a closer to the touch detection electrode 11 is attached to the liquid crystal display panel 30 in the present embodiment, and the first substrate (10c) of the touch panel 20a serves as a cover substrate 10c for protecting the display screen (touch surface) of the electronic device.

As shown in FIG. 6, the electronic device 50c includes a liquid crystal display device 40b, and a casing 44 for accommodating the liquid crystal display device 40b.

As shown in FIG. 6, the liquid crystal display device 40b includes the liquid crystal display panel 30, and the touch panel 20a provided on the liquid crystal display panel 30 with an adhesive layer 25b interposed therebetween. Note that the adhesive layer 25b is formed by a material similar to that of the adhesive layer 25a of Embodiment 1.

As shown in FIG. 6, the casing 44 includes a rectangular opening so that the main part (the display area) of the touch panel 20a is exposed therethrough, and the cover substrate 10c which is the first substrate of the touch panel 20a is fitted into the opening.

With the electronic device 50c of the present embodiment, the frame area can be reduced as much as possible and the manufacturing efficiency can be improved, as in Embodiment 1. In addition, since the cover substrate 10c for protecting the surface of the electronic device 50c and the first substrate of the touch panel are provided as a shared member, the generation of reflected light due to the substrate of the touch panel is reduced and it is possible to improve the display quality of the electronic device 50c. It is also possible to reduce the thickness of the electronic device 50c. Moreover, the manufacturing process is simplified, and it is easier to improve the manufacturing yield.

### Embodiment 3 of Invention

FIG. 7 is a cross-sectional view showing a liquid crystal display device 40c of the present embodiment.

While the cover substrate 10c of the electronic device 50c is used to form the first substrate of the touch panel 20a in Embodiment 2, the counter substrate 32 of the liquid crystal display panel 30 is used to form the first substrate 10 of the touch panel 20a in the present embodiment.

As shown in FIG. 7, the liquid crystal display device 40c includes the liquid crystal display panel 30, the touch panel 20a in which the counter substrate 32 of the liquid crystal display panel 30 is used as the first substrate 10, and a cover substrate 9 provided on the touch panel 20a with an adhesive layer 25c interposed therebetween. Here, the cover substrate 9 is a glass substrate, a plastic substrate, or the like. The adhesive layer 25c is formed by a material similar to that of the adhesive layer 25a of Embodiment 1. Note that FIG. 7 shows polarizers 33a and 33b attached to the upper surface and the lower surface, respectively, of the liquid crystal display panel 30.

With the liquid crystal display device 40c of the present embodiment, the frame area can be reduced as much as possible and the manufacturing efficiency can be improved, as in Embodiments 1 and 2. In addition, since the first substrate 10 of the touch panel 20a and the counter substrate 32 of the liquid crystal display panel 30 are provided as a shared member, the generation of reflected light due to the substrate of the touch panel is reduced and it is possible to improve the display quality of the liquid crystal display device 40c. It is also possible to reduce the thickness of the liquid crystal display device 40c. Moreover, the manufacturing process is simplified, and it is easier to improve the manufacturing yield.

### Embodiment 4 of Invention

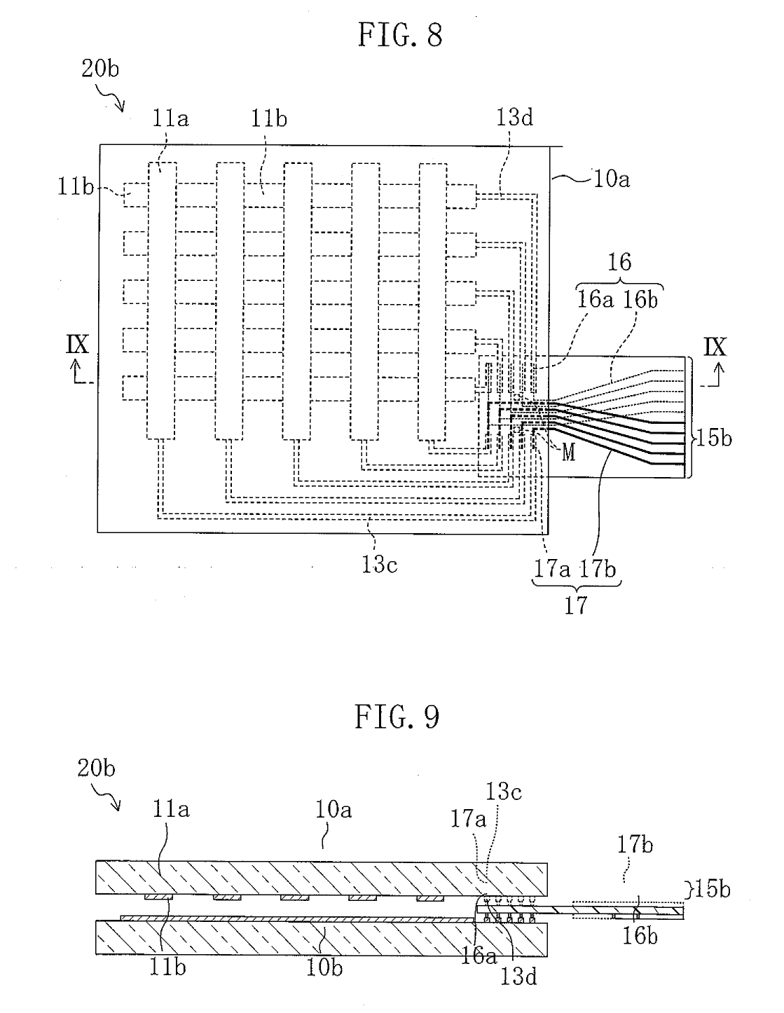

FIG. 8 is a plan view showing a touch panel 20b of the present embodiment, and FIG. 9 is a cross-sectional view showing the touch panel 20b taken along line IX-IX in FIG. 8.

While the embodiments employ the analog-type capacitive touch panel 20a, the resistive touch panel 20b of a digital-type (matrix-type) is employed in the present embodiment.

As shown in FIGS. 8 and 9, the touch panel 20b includes: an upper side first substrate 10a such as a glass substrate, for example; a lower side first substrate 10b such as a glass substrate provided so as to oppose the upper side first substrate 10a with spacers (not shown) interposed therebetween; and a rectangular second substrate 15b such as a double-sided FPC interposed between one end portion (the right side in FIG. 8) of the upper side first substrate 10a and that of the lower side first substrate 10b and secured by an ACF, or the like, in an area along one side edge (the right side in FIG. 8) of the upper side first substrate 10a and the lower side first substrate 10b.

As shown in FIGS. 8 and 9, a plurality of touch detection electrodes 11a are provided, using a transparent conductive film such as ITO, so as to extend parallel to each other on the lower surface of the upper side first substrate 10a, and a plurality of first lead lines 13c are provided so as to be routed in the counterclockwise direction to an area along one side edge (the right side in FIGS. 8 and 9) from the end portions of the touch detection electrodes 11a along the periphery of the substrate.

As shown in FIGS. 8 and 9, a plurality of touch detection electrodes 11b are provided, using a transparent conductive film such as ITO, so as to extend parallel to each other on the upper surface of the lower side first substrate 10b, and a plurality of second lead lines 13d are provided so as to be routed in the clockwise direction to an area along one side edge (the right side in FIGS. 8 and 9) from the end portions of the touch detection electrodes 11b along the periphery of the substrate. Here, the touch detection electrodes 11b are provided so as to extend perpendicular to the touch detection electrodes 11a as shown in FIG. 8.

As shown in FIG. 8, linear connection terminals (T) are provided at the end portions of the first lead lines 13c and the second lead lines 13d so as to extend along one side edge (the right side in FIG. 8) of the upper side first substrate 10a and the lower side first substrate 10b.

For each of the first lead lines 13c and the second lead lines 13d, the connection terminals T are provided so as to lie next to each other as shown in FIG. 8.

As shown in FIG. 8, a pair of alignment marks M for aligning the second substrate 15b with the upper side first substrate 10a and the lower side first substrate 10b are provided between the area where the connection terminals (T) of the first lead lines 13c are provided and the area where the connection terminals (T) of the second lead lines 13d are provided so that the alignment marks M are spaced apart from each other in a direction along one side edge (the right side in FIG. 8) of the upper side first substrate 10a and the lower side first substrate 10b.

As shown in FIGS. 8 and 9, a plurality of generally L-shaped external lines 17 are provided on the upper surface of the second substrate 15b so as to be connected to the connection terminals (T) of the first lead lines 13c on the upper side first substrate 10a.

As shown in FIG. 8, the external line 17 includes a connection portion 17a provided so as to overlap the connection terminal (T) of the first lead line 13c, and a line portion 17b provided so as to be bending from the connection portion 17a to extend in a direction away from the touch detection electrodes 11a and 11b. Here, the external line 17 is formed by a copper foil forming one of the conductive wire layers of a double-sided FPC, or the like.

An insulating layer made of an organic resin film is provided on the upper surface of the second substrate 15b so as to cover the line portions 17b of the external lines 17. Note that the insulating layer is formed by one of the cover films forming a double-sided FPC, or the like.

As shown in FIGS. 8 and 9, a plurality of generally L-shaped external lines 16 are provided on the lower surface of the second substrate 15b so as to be connected to the connection terminals (T) of the second lead lines 13d on the lower side first substrate 10b.

As shown in FIG. 8, the external line 16 includes a connection portion 16a provided so as to overlap the connection terminal (T) of the second lead line 13d, and a line portion 16b provided so as to be bending from the connection portion 16a to extend in a direction away from the touch detection electrodes 11a and 11b. Here, the external line 16 is formed by a copper foil forming the other conductive wire layer of a double-sided FPC, or the like.

An insulating layer made of an organic resin film is provided on the lower surface of the second substrate 15b so as to cover the line portions 16b of the external lines 16. Note that the insulating layer is formed by the other cover film forming a double-sided FPC, or the like.

With the touch panel 20b of the present embodiment, the frame area can be reduced as much as possible as in Embodiments 1-3, and a reliable pen input can be realized since the touch panel 20b is a resistive touch panel.

With the touch panel 20b of the present embodiment, a pair of alignment marks M are provided so as to be apart from each other along one side edge of the upper side first substrate 10a and the lower side first substrate 10b. Therefore, by aligning the second substrate 15b with the upper side first substrate 10a and the lower side first substrate 10b so that a pair of alignment marks of the upper side first substrate 10a and the lower side first substrate 10b are aligned with a corresponding pair of alignment marks M of the second substrate 15b, it is possible to reduce the angular misalignment of the second substrate 15b with respect to the upper side first substrate 10a and the lower side first substrate 10b, and it is possible to reduce the misalignment of the second substrate 15b with respect to the upper side first substrate 10a and the lower side first substrate 10b in a direction along one side edge of the upper side first substrate 10a and the lower side first substrate 10b, thereby reducing short-circuiting, etc., and improving the manufacturing yield and the product quality.

### Embodiment 5 of Invention

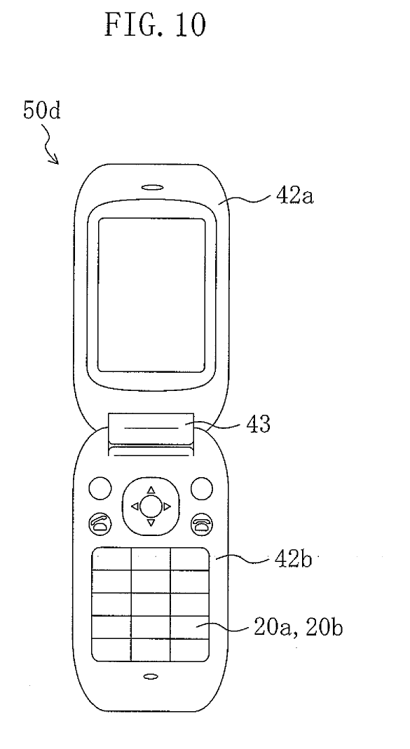

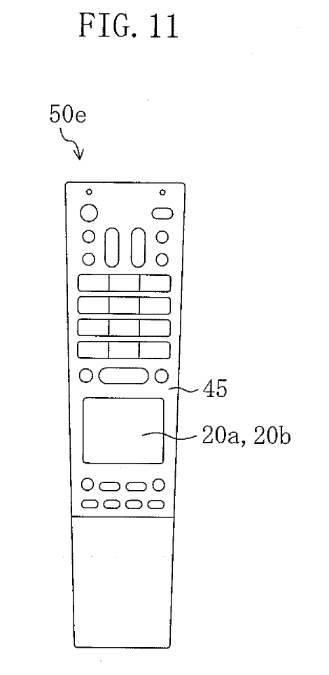

FIG. 10 is a cross-sectional view showing a mobile telephone 50d of the present embodiment, and FIG. 11 is a cross-sectional view showing a remote controller 50e of the present embodiment.

While the embodiments above each employ an electronic device including a touch panel on the display screen, the present embodiment employs an electronic device including a touch panel other than the display screen.

As shown in FIG. 10, the mobile telephone 50d includes the touch panel 20a of Embodiments 1-3 or the touch panel 20b of Embodiment 4 in a push dial portion of the second casing 42b. With the mobile telephone 50d, since the frame area of the touch panel 20a (20b) is reduced, it is possible to reduce the width of the frame area of the second casing 42b, thereby reducing the size of the device body.

As shown in FIG. 11, the remote controller 50e includes the touch panel 20a of Embodiments 1-3 or the touch panel 20b of Embodiment 4 in a touch pad portion of a casing 45 where various control buttons are provided. Here, the remote controller 50e is configured so that various controls can be done on the TV screen, for example, by touching the surface of the touch pad portion with a finger. With the remote controller 50e, since the frame area of the touch panel 20a (20b) is reduced, it is possible to reduce the width of the frame area of the casing 45, thereby reducing the size of the device body.

Note that with the electronic device of the present embodiment, since the touch panel is not provided on the display screen, a semi-transparent or opaque substrate can be used as the first substrate of the touch panel.

While the above embodiments each employ a configuration where the external lines and the lead lines are bent in the area along one side edge of the substrate, the external lines and the lead lines may not all be bent in the area along one side edge of the substrate in the present invention.

While the above embodiments each employ a TFT-type liquid crystal display device as a display device, the present invention is also applicable to other display devices such as liquid crystal display devices of DUTY-type, polysilicon-type, etc., organic EL (electro luminescence) display devices, plasma display devices, electronic papers, etc.

While the above embodiments employ analog-type capacitive and digital-type resistive touch panels, the present invention is also applicable to digital-type capacitive touch panels and analog-type resistive touch panels and also to other touch panels such as electromagnetic induction touch panels, i.e., touch panels where coordinate values or input signals such as ON/OFF can be generated by touching or pressing them with a finger, a pen, or the like.

While the above embodiments employ digital cameras, mobile telephones and remote controllers as electronic devices, the present invention is also applicable to electronic devices such as television sets, personal computers, portable game machines, radios, music tools, DVD players, and position information navigation tools.

### INDUSTRIAL APPLICABILITY

As described above, since the present invention can reduce the frame area of a touch panel, the present invention is useful for various electronic devices including touch panels.

### DESCRIPTION OF REFERENCE CHARACTERS

F Frame area
M Alignment mark
T Connection terminal
10 First substrate
10a Upper side first substrate
10b Lower side first substrate
10c Cover substrate (first substrate)
11, 11a, 11b Touch detection electrode
13a, 13c First lead line
13b, 13d Second lead line
15a, 15b Second substrate
16, 17 External line
16a, 17a Connection portion
16b, 17b Line portion
20a, 20b Touch panel
30 Liquid crystal display panel
31 Active matrix substrate
32 Counter substrate
40a-40c Liquid crystal display device
50a Digital camera (electronic device)
50b, 50d Mobile telephone (electronic device)
50c Electronic device
50e Remote controller (electronic device)

1. A touch panel comprising:
a touch detection electrode provided on a rectangular first substrate so as to be capable of touch detection;
a lead line routed from the touch detection electrode along a periphery of the first substrate to an area along one side edge of the first substrate, the lead line including a connection terminal formed in the area; and
an external line provided on a second substrate secured to the area along the one side edge of the first substrate and connected to the connection terminal, wherein
a touched position on the touch detection electrode is detected via the lead line and the external line,
the connection terminal of the lead line is formed in a linear pattern along the one side edge of the first substrate, and
the external line includes a connection portion provided so as to overlap the connection terminal, and a line portion bending from the connection portion to extend in a direction away from the touch detection electrode.

2. The touch panel of claim 1, wherein
the second substrate is a flexible substrate having flexibility.

3. The touch panel of claim 1, wherein
a plurality of lead lines are provided for the touch detection electrode, and
the connection terminals of the lead lines are provided so as to be next to each other.

4. The touch panel of claim 1, wherein
a plurality of lead lines are provided for the touch detection electrode, and
the plurality of lead lines include a first lead line routed from the touch detection electrode in one of a clockwise direction and a counterclockwise direction, and a second lead line routed from the touch detection electrode in the other one of the clockwise direction and the counterclockwise direction.

5. The touch panel of claim 4, wherein
an alignment mark for aligning the first substrate and the second substrate with each other is provided between a connection terminal of the first lead line and a connection terminal of the second lead line.

6. The touch panel of claim 5, wherein
a pair of alignment marks are provided so as to be spaced apart from each other along the one side edge of the first substrate.

7. The touch panel of claim 5, wherein
a pair of alignment marks are provided so as to be spaced apart from each other in a direction perpendicular to one side edge of the first substrate.

8. The touch panel of claim 1, wherein
a touched position on the touch detection electrode is detected by a capacitive system.

9. The touch panel of claim 8, wherein
the touch detection electrode is provided in a rectangular shape entirely across an area inside a frame area defined along the periphery of the first substrate.

10. A display device comprising the touch panel of claim 1.

11. The display device of claim 10, comprising:
a display panel including a pair of substrates arranged opposing each other,
wherein the first substrate is one of the pair of substrates.

12. An electronic device comprising the display device of claim 10.

13. The electronic device of claim 12, comprising:
a cover substrate for protecting a surface,
wherein the first substrate is the cover substrate.

14. An electronic device comprising the touch panel of claim 1.

15. The electronic device of claim 14, comprising:
a cover substrate for protecting a surface,
wherein the first substrate is the cover substrate.
